(19) United States
(12) Patent Application Publication
(10) Pub. No.: US 2004/0220725 A1
(43) Pub. Date: Nov. 4, 2004

(54) Method and apparatus for avoiding route deviation

(76) Inventor: Steven D. Cheng, San Diego, CA (US)

Correspondence Address: Cynthia L. Pillote, Snell & Wilmer L.L.P., One Arizona Center, 400 East Van Buren, Phoenix, AZ, 85004-2202, US

(21) Appl. No.: 10/394,390

(22) Filed: Mar. 21, 2003

(51) Int. Cl. G01C 21/00

(52) U.S. Cl. 701/207; 455/456.1

(57) ABSTRACT

The present invention provides a method and apparatus for avoiding route deviation for a moving object in an area of a communication system. The mobile communication system includes a plurality of cells. Each cell has a location area identification data (LAI) relating to location and coverage of each cell. In the present invention, a route information is inputted, and then is mapped with the LAI data to determine cells corresponding to the route information. The present invention detects a position of the object and determines whether the object is in the determined cells. When the object is not in the determined cells, the present invention outputs a warning signal.

### FIELD OF INVENTION

The present invention relates to a method and apparatus for avoiding route deviation, and more particularly, to a method and apparatus for warning users by means of a mobile communication system as route deviation occurs.

### BACKGROUND OF THE INVENTION

Generally speaking, for a short distance driving to a destination, people or drivers usually can memorize familiar environments along the route and drive on the right road to reach the destination. However, in a long or new journey, even with the assistance of a map, people or drivers might make mistakes and lose their tracks. Thus, if someone or something can remind people when they are too far away from the planned route, people will not waste time in finding their current position during the journey.

Since personal communication service has become popular, various mobile units are used to communicate with others. Additionally, a method and apparatus capable of reminding users of route deviation by means of a mobile communication system is desired.

### SUMMARY OF THE INVENTION

The objective of the present invention is to provide a method and apparatus for avoiding route deviation for a moving object in an area of a mobile communication system. The mobile communication system has a plurality of cells. Each cell contains a location area identification data (LAI) recording information about location and coverage of each cell, such as mobile countly code (MCC), mobile network code (MNC), location area code (LAC). By the LAI data, the object can approximately determine its current position.

A method of the exemplary embodiment of the present invention begins with determining a route information including a start point, an end point, and a planned route. Then, the route information is mapped with the LAI data to determine cells respectively corresponding to the start point, the end point, and the planned route. The cells corresponding to the start point are defined as a first area. The cells corresponding to the end point are defined as a second area. The cells corresponding to the planned route are defined as a third area. Next, the method detects a position of the object and then determines whether the object is in the first area. As the object starts and moves forward, the method further determines whether the object is in the second area. If the object is in the second area, it has already arrived at the destination of the planned route. If the object is not in the second area, the method determines whether the object is in the third area. If the object is not in the third area, the present invention outputs a warning signal.

Furthermore, the exemplary apparatus of the present invention includes an input unit, a process unit, a memory unit, a detection unit, a determination unit, and a warning unit. The memory unit stores the LAI data. The input unit inputs a route information including a start point, an end point, and a planned route. The process unit maps the route information with the LAI data to determine cells respectively corresponding to the start point, the end point, and the planned route. The cells corresponding to the start point are defined as a first area. The cells corresponding to the end point are defined as a second area. The cells corresponding to the planned route are defined as a third area. The detection unit detects a position of the object. Then, the determination unit determines whether the object is in the first area. If the object is not in the first area, the determination unit determines whether the object is in the second area. When the object is not in the second area, the determination unit determines whether the object is in the third area. When the object is not in the third area, the warning unit outputs a warning signal.

### BRIEF DESCRIPTION OF THE DRAWINGS

FIG. 1 is a schematic block diagram of an apparatus for avoiding route deviation according to an embodiment of the present invention;

FIG. 2 shows a schematic diagram of route information according to an embodiment of the present invention;

FIG. 3 shows a schematic diagram of comparison between the route information and location area identification data (LAI) according to an embodiment of the present invention;

FIG. 4 is a schematic block diagram of a detection unit of an apparatus for avoiding route deviation according to an embodiment of the present invention;

FIG. 5 is a flow chart of a method for avoiding route deviation according to an embodiment of the present invention; and

FIG. 6 is a flow chart of a method for detecting position of the object according to an embodiment of the present invention.

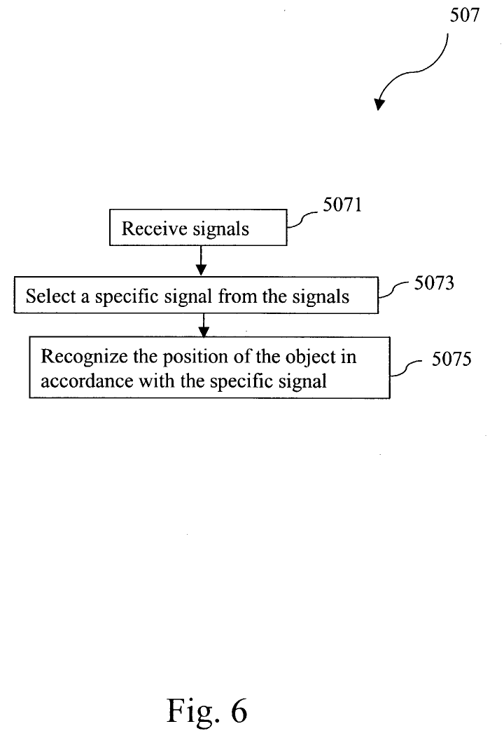

### DETAILED DESCRIPTION

The present invention relates to a mobile unit for reminding people when their current location is too far away from a predetermined route by sending a warning signal. Thus, users don't have to worry about getting lost and can reach the destination successfully.

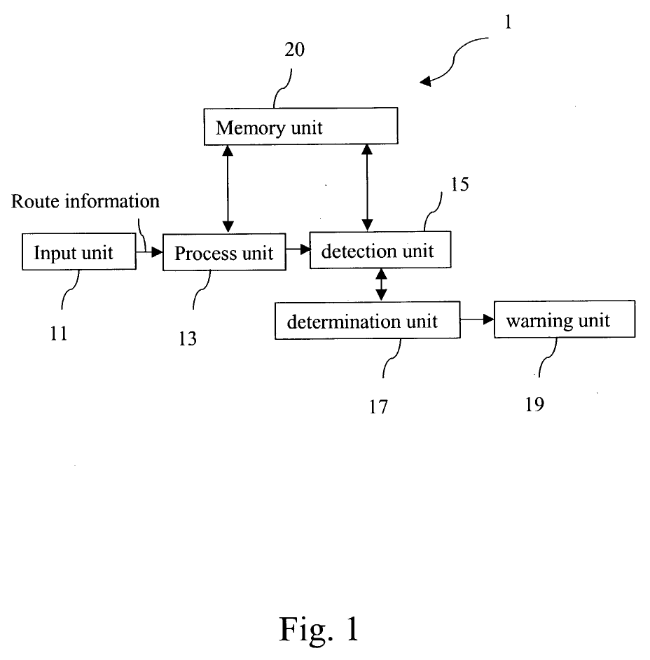

FIG. 1 shows an apparatus for avoiding route deviation according to an embodiment of the present invention. The present invention provides an apparatus 1 for avoiding route deviation for a moving object in an area of a mobile communication system.

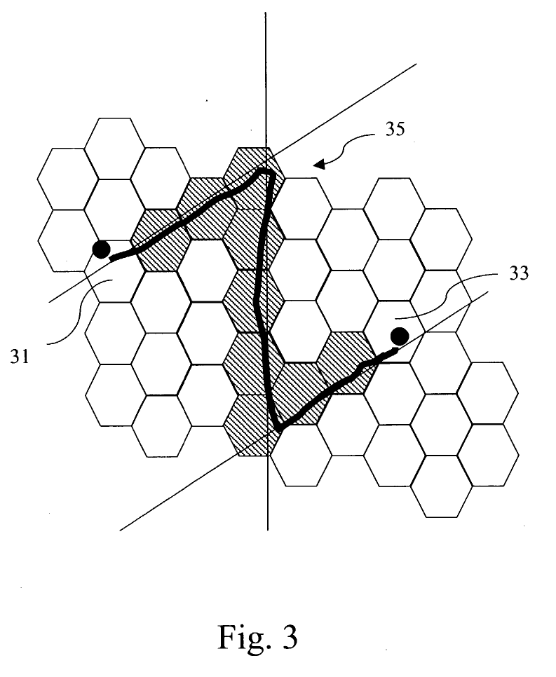

In the illustrated embodiment, the communication system has a plurality of cells, as shown in FIG. 3. The communication system contains a location area identification data (LAI) recording information about location and coverage of each cell, such as mobile country code (MCC), mobile network code (MNC), location area code (LAC). By the LAI data, the object can approximately determine its current position. The mobile communication system can be a global system for mobile (GSM), a general packet radio service (GPRS) or a wide-band code division multiple access (WCDMA) system and so forth. Each cell has a base station therein. The base station respectively sends out a signal containing its LAI data. The object mentioned here is a mobile unit carried by a user, such as a cell phone, personal digital assistant (PDA), or other mobile devices. The signal can be a broadcast control channel signal (BCCH). However, the present invention is not limited by the described embodiment. Other embodiments not shown herein equally possible within the scope of the invention are in the scope of the present invention.

As shown in FIG. 1, the apparatus 1 of the present invention carried by a user includes an input unit 11, a process unit 13, a memory unit 20, a detection unit 15, a determination unit 17, and a warning unit 19. The memory unit 20 stores the LAI data of the communication system. To optionally ensure that the data about location and coverage of each of the cells saved in the memory unit 20 are exactly correct, the LAI data should be updated by additional optional devices.

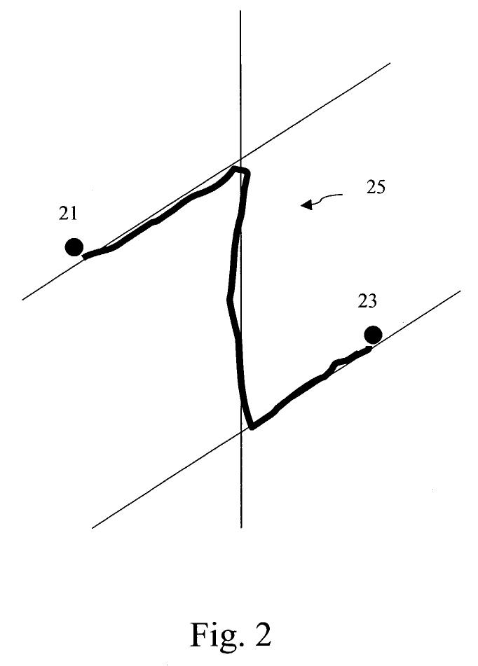

As shown in FIG. 1 and FIG. 2, the user begins with inputting a route information by means of the input unit 11. The route information includes a start point 21, an end point 23, and a planned route 25. In the illustrated embodiment, the input unit 11 may include a graphic user interface or other software for users to input information. For example, user can input names of start/end points directly or use a pen pointer to select start/end points from the graphic user interface. Instead of limiting the input manners, any other ways to input the route information can be applied in the present invention.

The process unit 13 maps the route information with the LAI data to determine cells respectively corresponding to the start point 21, the end point 23, and the planned route 25. As shown in FIG. 3, the present invention defines: the cells corresponding to the start point 21 as a first area 31; the cells corresponding to the end point 23 as a second area 33; and the cells corresponding to the planned route 25 as a third area 35 (area of shadow).

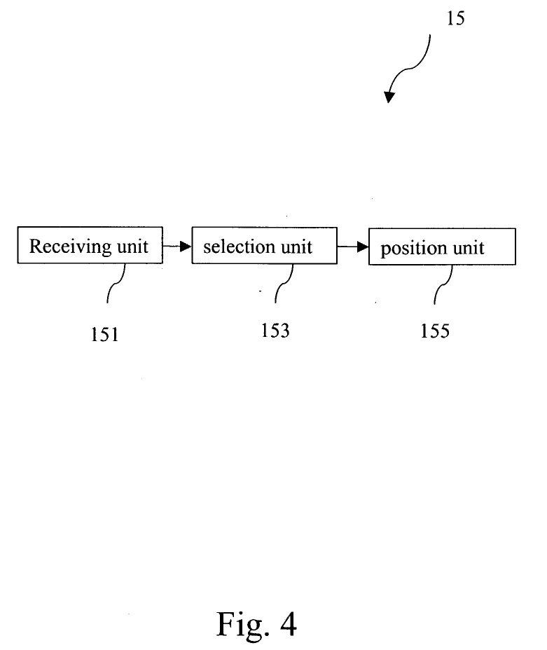

After determining the first area 31, the second area 33, and the third area 35, the detection unit 15 begins to detect a position of the object. As shown in FIG. 4, the detection unit 15 further includes a receiving unit 151, a selection unit 153, and a position unit 155.

In order to detect the position of the object in the system, the receiving unit 151 receives the signals broadcasted from base stations of nearby cells. The selection unit 153 selects a specific signal from those received signals and reads out a specific LAI data from the specific signal. The position unit 155 recognizes the position of the object by comparing the specific LAI data with the LAI data stored in memory unit 20. In the embodiment, the selection unit 153 selects one of the received signals with the strongest signal power as the specific signal. However, the selection manner described above is not a limitation in the present invention.

After figuring out the position of the object by the detection unit 15, the determination unit 17 determines whether the object is in the first area 31. If the object is not in the first area 31, it is apparent that the object does not start off from the predetermined starting point 21. Thus, the user must have deviated from the route. The warning unit 19 then outputs a warning signal.

The determination unit 17 further includes a timer (not shown). The timer has a predetermined time value. When the object is in the first area 31, the clock begins to count. In the meantime, the determination unit 17 determines whether the time value is greater than the predetermined time value. When the time is greater than the predetermined time value, the detection unit 15 will detect the current position of the object again to prevent the loss of the position of the object when the object moves.

As the object starts moving forward, the determination unit 17 determines whether the object is in the second area 33. If the object is not in the second area 33, it is apparent that the object does not reach the end point 23 yet. The determination unit 17 determines whether the object is in the third area 35. When the object is not in the third area 35, it is apparent that the object neither reaches the end point 23 nor moves along the planned route 25. The warning unit 19 then outputs a warning signal to remind the user of moving on the wrong road. Alternatively, the determination unit 17 of the present invention may determine whether the object is in the third area 35 beforehand. When the object is not in the third area 35, the determination unit 17 determines whether the object is in the second area 33. Sequence of the determining steps of the determination unit 17 is not a limitation in the present invention. Any other similar functions or determining methods resulting in similar effects are also in the scope of the present invention.

Whenever route deviation occurs, the apparatus 1 for avoiding route deviation of the present invention outputs a warning signal to remind users of stopping going astray. Thus, users don't have to worry about getting lost and can successfully reach the destination.

In order to make characteristics and feathers of the present invention fully understood, the following description shows a method for avoiding route deviation of the present invention.

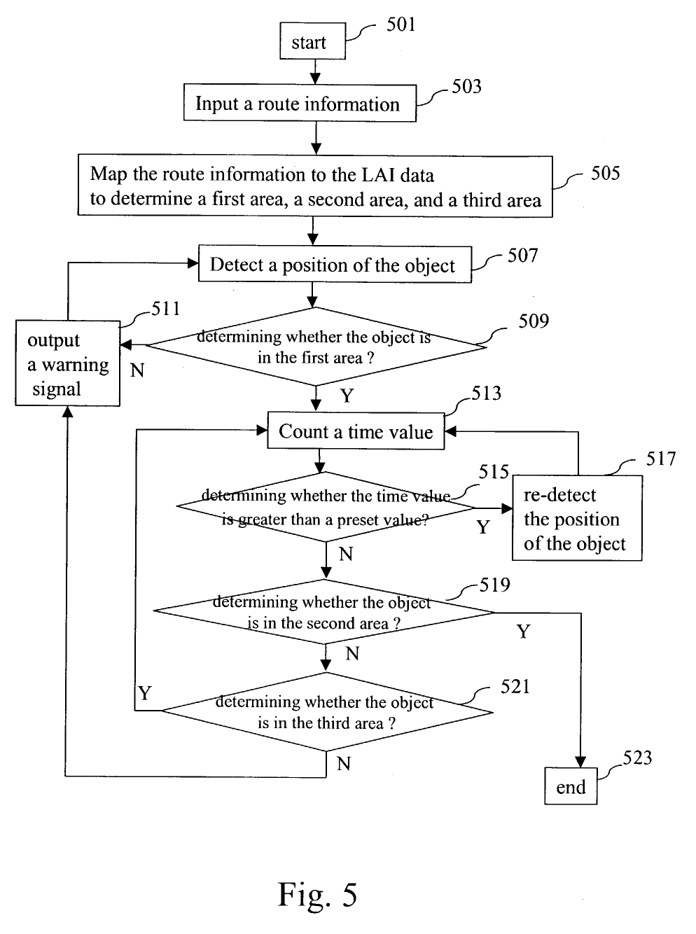

FIG. 5 shows a flowchart of the method for avoiding route deviation according to an embodiment of the present invention. As shown in FIG. 5, the method of the present invention includes steps 501 to 523.

First of all, in the step 503, users input route information. The route information includes a start point, an end point, and a planned route. In the illustrated embodiment, users may apply a graphic user interface or other software to input information. Instead of limiting the input manners, any other ways to input route information can be applied in the present invention.

In the step 505, the route information is mapped with the LAI data of the system to determine cells respectively corresponding to the start point, the end point, and the planned route. Here, the present invention defines: the cell corresponding to the start point as a first area, the cell corresponding to the end point as a second area; and the cells corresponding to the planned route as a third area.

In the step 507, the present invention begins to detect a position of the object. In order to detect the position of the object, the step 507 further includes a step 5071 to a step 5075. In the step 5071, the object receives a plurality signals from base stations of nearby cells. In the step 5073, a specific signal is selected and a specific LAI data is received from the specific signal. In the step 5075, the present invention then recognizes the position of the object by comparing the specific LAI data with the LAI data. In the embodiment, in the step 5073, the specific signal selected from the signals has the strongest signal power. However, the selection manner described above is not a limitation in the present invention.

After figuring out the position of the object, the method, in the step 509, determines whether the object is in the first area. If the object is not in the first area, the object did not start off from the predetermined starting point. Thus, the user must have deviated from the route. In the step 511, a warning signal then is outputted.

When the object is in the first area, the method, in the step 513, begins to count a time. In the meantime, the method, in the step 515, determines whether the time is greater than a preset time value. When the time is greater than the preset time value, in the step 517, the method will re-detect the current position of the object to prevent the loss of the position of the object.

As the object starts moving forward, in the step 519, the method determines whether the object is in the second area. When the object is not in the second area, it is apparent that the object does not reach the end point yet. The method then proceeds to the step 521. In the step 521, the method determines whether the object is in the third area. When the object is not in the third area, it is apparent that the object neither reaches the end point nor moves along the planned route. A warning signal, in the step 511, is then outputted to remind the user of moving on the wrong road. Alternatively, the sequence between the steps 519 to 521 is not a limitation in the present invention. Any other similar functions or determining methods resulting in similar effects are also in the scope of the present invention.

Whenever route deviation occurs, the method for avoiding route deviation of the present invention outputs a warning signal to remind users of stopping going astray. Thus, users don't have to worry about getting lost and can successfully reach the destination.

In the foregoing specification the invention has been described with reference to specific embodiments. It will, however, be evident that various modification and changes may be made to thereto without departing from the broader spirit and scope of the invention. The specification and drawings are, accordingly, to be regarded in an illustrative rather than restrictive sense. Thus, it is intended that the present invention covers the modification and variations of this invention provided they come within the scope of the appended claims and their equivalents.

1. A method for avoiding route deviation for a moving object in an area of a mobile communication system, said mobile communication system including cells, each cell having a location area identification (LAI) data, said LAI data related to location and coverage of each cell, said method comprising the steps of:
(a) inputting a route information including a start point, an end point, and a planned route;
(b) mapping said route information with said LAI data to determine cells respectively corresponding to said start point as a first area, corresponding to said end point as a second area, and corresponding to said planned route as a third area;
(c) detecting a position of said object;
(d) determining whether said object is in said first area;
(e) determining whether said object is in said second area;
(f) determining whether said object is in said third area; and
(g) outputting a warning signal.

2. The method of claim 1, wherein between said step (d) and said step (e), the method further comprises the steps of:
(h) counting a time value when said object is in said first area;
(i) determining whether said time value is greater than a predetermined value; and
(j) re-detecting said position of said object when said time value counted is greater than said predetermined value.

3. The method of claim 1, wherein said step (d) further comprises:
(d.1) outputting said warning signal when said object is not in said first area.

4. The method of claim 1, said step (c) further comprising:
(c.1) receiving a plurality of signals from said cells;
(c.2) selecting a specific signal from said signals and reading out a specific LAI data from said specific signal; and
(c.3) recognizing said position of said object by comparing said specific LAI data with said LAI data.

5. The method of claim 4, wherein said signal is a broadcast control channel signal (BCCH) sent out from each of said base stations.

6. The method of claim 4, wherein in the step (c.2), said specific signal is one of said signals of the strongest signal power.

7. The method of claim 1, wherein said object is a mobile station.

8. The method of claim 1, wherein said object is a personal digital assistant (PDA).

9. An apparatus for avoiding route deviation for a moving object in an area of a mobile communication system, said mobile communication system including cells, each cell having a location area identification data (LAI), said LAI data related to location and coverage of each cell, said apparatus comprising:
an input unit for inputting a route information including a start point, an end point, and a planned route;
a process unit for mapping said route information with said LAI data to determine cells respectively corresponding to said start point as a first area, corresponding to said end point as a second area, and corresponding to said planned route as a third area;
a detection unit for detecting a position of said object;
a memory unit for storing said LAI data;
a determination unit; and
a warning unit;
whereby said determination unit determines whether said object is in said second area; when said object is not in said second area, said determination unit determines whether said object is in said third area; and when said object is not in said third area, said warning unit outputs a warning signal.

10. The apparatus of claim 9, wherein said determination unit further determines whether said object is in said first area.

11. The apparatus of claim 9, wherein said determination unit further comprises a timer, when said determination unit determines said object is in said first area, said timer counts a time value; said determination unit determines whether said time value counted is greater than a predetermined value; and when said time value counted is greater than said predetermined value, said detection unit re-detects said position of said object.

12. The apparatus of claim 9, wherein said detection unit further comprises:
a receiving unit for receiving a plurality of signals from said cells;
a selection unit for selecting a specific signal from said signals and reading out a specific LAI data from said specific signal; and
a position unit for recognizing said position of said object by comparing said specific LAI data with said LAI data.

13. The apparatus of claim 12, wherein said signal is a broadcast control channel signal (BCCH) sent out from each of said base stations.

14. The apparatus of claim 12, wherein said selection unit selects one of said signals of the strongest signal power as said specific signal.

15. The apparatus of claim 9, wherein said object is a mobile station.

16. The apparatus of claim 9, wherein said object is a personal digital assistant (PDA).
